(19) United States
(12) Patent Application Publication
(10) Pub. No.: US 2013/0208789 A1
(43) Pub. Date: Aug. 15, 2013

(54) Method And System Of Improving Quality Of Video Beaming

(71) Applicant: Screenovate Technologies Ltd., (US)

(72) Inventor: Matan Shapira, Tel Aviv (IL)

(73) Assignee: SCREENOVATE TECHNOLOGIES LTD., Ra'anana (IL)

(21) Appl. No.: 13/762,960

(22) Filed: Feb. 8, 2013

Related U.S. Application Data
(60) Provisional application No. 61/596,757, filed on Feb. 9, 2012.

(51) Int. Cl. H04N 5/38

(52) U.S. Cl. CPC H04N 5/38; H04N 19/00169
USPC 375/240.02; 348/723

(57) ABSTRACT

A method for improving quality of video beaming of any content by a beaming application that is running on a computerized mobile device is provided herein. The method comprising the steps of: (iii) selecting content for beaming; (ii) beaming by utilizing a beaming application; (iii) identifying in real time a pattern change in beamed video, wherein the pattern change signifies transition from a previous rate of a predefined size of chunk of delivered data to a higher rate of currently delivered data in content displaying pattern by the application which starts a set of critical frames; (iv) performing quality improvement of the video beaming of the set of critical frames based on the identified pattern changes; and (v) identifying in real time a second pattern change in display video to a lower delivered data rate which ends the set of critical frames.

### BACKGROUND

1. Technical Field

The present invention generally relates to the field of beaming data of a Graphical User Interface (GUI) screen of an application on a remote screen by using video beaming technology.

2. Discussion of Related Art

Some video encoders, when configured to operate below a maximum output bit rate, increase the compression of video frames to maintain frame rate (i.e. not dropping frames) which results in decrease in the quality of images, especially when the rate of the input frame is high. When such video encoder is being used to encode a main display of a computing/media device, the encoded application video beaming (i.e. images) may be perceived by a user as in a decreased quality in some “key periods”.

An example for such “key periods” with decreased quality of images occurs immediately after a scrolling operation in a browser. The scrolling operation creates a high frame rate, as a result the encoder increases the compression of video frames and the quality of the images decreases.

In a “key period” which follows the end of the scrolling, when the user wants to read a text in the point where it was scrolled to in the webpage, the captured video of the beamed browser is displayed in a low quality to the user, which results in poor experience for the user of reading the text and watching pictures which are embedded in the text. After the user scrolled the webpage and reached a point in the text where the user is interested in i.e. once the user stopped scrolling the webpage and input frame rate is decreased or stopped or increase in content changes which appear on the screen (when the user is moving the mouse), the encoder starts outputting standard quality frame or gradually increase the frame quality. However, from the moment the user started scrolling and until the user reached a point of interest in the text, the user is provided with a low quality image of the video beaming.

### BRIEF SUMMARY

According to some embodiments of the invention, a method for improving quality of video beaming of any content by a beaming application that is running on a computerized mobile device is provided herein. The method is comprising the steps of: (i) selecting content for beaming; (ii) beaming selected content by utilizing a beaming application; (iii) identifying in real time a pattern change in beamed video, wherein the pattern change signifies transition from a previous rate of a predefined size of chunk of delivered data to a higher rate of currently delivered data in content displaying pattern by the application which starts a set of critical frames; (iv) performing quality improvement of the video beaming of the set of critical frames based on the identified pattern changes; and (v) identifying in real time a second pattern change in display video to a lower delivered data rate which ends the set of critical frames, wherein the identifying and the performing is running on at least one processing unit.

According to some embodiments of the invention, higher delivered data rate is compressed data.

According to some embodiments of the invention, higher delivered data rate is high bandwidth usage.

According to some embodiments of the invention, the identifying is achieved by analyzing characteristics of the video frames.

According to some embodiments of the invention, the performing of quality improvement of the video beaming is activated by selecting frames of the beaming video in low quality for quality improvement and applying quality improvement on the selected frames.

According to some embodiments of the invention, the performing of quality improvement is achieved by generating an additional frame with a higher quality and adding the additional frame to the video beaming.

According to some embodiments of the invention, the identifying of the change which signifies transition in content displaying pattern is performed according to information that is received from a User interface (UI) by attaching metadata tags which includes the information related to the beaming video frames.

According to some embodiments of the invention, the UI is of an Operating System (OS).

According to some embodiments of the invention, the UI is of the application that is running on the computerized mobile device.

According to some embodiments of the invention, the identifying of the change which signifies pattern change in displayed video is performed according to information that is received from an Operation System (OS) or a User interface (UI) by sending metadata tags and identification (ID) of the critical frames.

According to some embodiments of the invention, the identifying of the change which signifies transition in usage of the application is performed by analyzing an output bitrate of an encoder for detecting the change, wherein the change is characterized by a known pattern of bit rate.

According to some embodiments of the invention, the known pattern includes a high bit rate period with minimal length followed by a low bit rate period or a period with no input frames. (i) According to some embodiments of the invention, a beaming application for improving quality of video beaming by a processing unit that is running on a computerized mobile device is provided herein. The beaming application comprising: (i) a detector module for identifying in real time a pattern change in beamed video, wherein the pattern change signifies transition from a previous rate of a predefined size of chunk of delivered data to a higher rate of currently delivered data in content displaying pattern by the application; and (ii) a video encoding module for performing quality improvement of the beaming video after the identified a pattern change in beamed video.

According to some embodiments of the invention, the detector module is comprising of a frame analyzing module for monitoring bit rate of frames of the beaming video and detecting a change which signifies transition in usage of the application which starts a set of critical frames.

According to some embodiments of the invention, the detector module is part of a UI framework module for identifying critical frames based on information that is received from UI components; and a surface composition module for receiving information regarding critical frames from OS is part of the UI framework.

According to some embodiments of the invention, the UI framework module is further creating metadata tags to the identified critical frames and attaching the metadata tags to the critical frames.

According to some embodiments of the invention, the UI framework module is further creating metadata tags to the identified critical frames and identification (ID) of the critical frames and sends is separately from the critical frames.

According to some embodiments of the invention, the surface composition module is further attaching metadata tags which includes the information related to the beaming video frames.

According to some embodiments of the invention, the identifying of the change which signifies transition in usage of the application is performed by analyzing an output bitrate of an encoder for detecting the change, wherein the change is characterized by a known pattern of bit rate.

According to some embodiments of the invention, the known pattern includes a high bit rate period with minimal length followed by a low bit rate period or a period with no input frames.

According to some embodiments of the invention, the detector module identifies beginning of a set of critical frames and an end of the set of critical frames.

### BRIEF DESCRIPTION OF THE DRAWINGS

The present invention will be more readily understood from the detailed description of embodiments thereof made in conjunction with the accompanying drawings of which:

FIG. 1A is a block diagram, illustrating the modules of a beaming application in a computerized mobile device, wherein a detector module is separate to a UI framework, according to some embodiments of the invention;

FIG. 1B is a block diagram, illustrating the modules of a beaming application in a computerized mobile device, wherein a detector module is part of a UI framework, according to some embodiments of the invention;

FIG. 2 is a flowchart illustrating a process of video encoding module, according to some embodiments of the invention;

FIG. 3 is a flowchart illustrating a process of frames analyzing module, according to some embodiments of the invention;

FIG. 4 is a flowchart illustrating a process of User Interface (UI) framework, according to some embodiments of the invention; and

FIG. 5 is a block diagram illustrating a process of Surface composition module, according to some embodiments of the invention.

### DETAILED DESCRIPTION

Before explaining at least one embodiment of the invention in details, it is to be understood that the invention is not limited in its application to the details of construction and the arrangement of the components set forth in the following description or illustrated in the drawings. The invention is applicable to other embodiments and/or may be practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The term “screen Graphical User Interface (GUI)” as used herein in this application is define as data and appearance of application screens such as a video screen or messaging application screen.

The term “key period” as used herein in this application is defined as a period in which there is a transition in content displaying pattern of an application which starts a set of critical frames, For example, when a user focuses in a specific area in a screen to perceive the details of the content that is appearing on the screen after an action of the user such as scrolling. For example, when the user is reading a text or watching an image or reviewing a webpage or increase in content changes which appear on the screen in a non limiting example, when the user is moving the mouse. The key period is as opposed to a period when scrolling a webpage, or while loading an application on a computerized mobile device. That period is quite a passive period in which the user is not focused on the screen, and not trying to perceive the details of the content that is displayed on the screen. In another example, a video movie may be comprised of parts with higher level of compression of data and other parts with a lower level of compression. Also, a key period may be a period when there is an increase in content changes in a specific frame.

The term “beaming” as used in this application is defined as the communication of screen content encoded data between a computerized mobile device and a target display device such as iPhone airplay mirroring.

The term “delivered data” as used in this application is defined as the delivered data before compression or before high bandwidth usage.

The term “intra-coded pictures (I-frame)” as used in this application is defined as a fully specified picture (like a conventional static image file) in process of video compression stream. There are two types of inter frames: Predicted picture (P-frames) and Bi-predicted picture (B-frames). P-frames and B-frames hold only part of the image information, so they need less space for storage than an I-frame, and thus improve video compression rates.

The term “video beaming” as used in this application is defined as the action of projecting content of an application that is running on a computerized mobile device on a remote screen by utilizing video format technology and video transmission protocols.

The present invention provides a system and method for improving the user's experience by increasing the image quality in key periods in which an output data of a video encoder is displayed in low quality. A user may beam content that is displayed on a screen of a computerized mobile device. The content may be beamed by a beaming application that is utilizing video technology.

The method according to the present invention, improves user's experience by increasing the quality of a selected frame at the key period. The frame is selected by identifying the last frame of an action which is known to generate a high frame rate which results in low quality video output. Examples for such actions, which generate a high frame rate, are scrolling, rotating, switching between application screens or animations. The identifying may be achieved by analyzing characteristics of the video frames in different techniques as will be further explained below.

According to some embodiments of the invention, an improvement in the quality of the frame during the key period is a result of a first set of low quality frames before the key period (during the action period) and a frame with a higher quality at the beginning of the key period. The higher quality frame is configured as an I-frame.

According to some embodiments of the present invention the user's experience is improved by adding an additional high quality frame (instead of increasing a quality of a frame), at the beginning of the key period. The added frame is identical to the last low quality frame, having less compressed rate and hence in higher quality. The added frame is configured as an I-frame.

According to some embodiments of the present invention, a detection process for identifying in real time, a critical frame in key periods for providing higher quality frame in this period. The identification can be implemented using two techniques. The two techniques of detecting the critical frames may exist at the same implementation, and complete the operation of each other.

According to some embodiments of the present invention, one technique is using metadata tags that maybe attached to frames based on information that is arriving from various Operating Systems (OS)s and User Interface (UI) components. Alternatively, the metadata tags may be separate from the frames and may be sent with frames ID. The metadata tags indicate for each frame if it's the critical frame in the timeline at the beginning of a key period. For example, attaching this metadata tags to a frame according to information from a scrolling UI component indicating that this rendered frame is the last frame of a key period in a non limiting example, a scroll of website action.

According to some embodiments of the present invention, second technique is implemented by analyzing the output bit rate of the encoder in real time for detecting beginning of a key period. The key period is characterized by a known pattern of bit rate. The known pattern includes a high bit rate period with minimal length followed by a low bit rate period or a period with no input frames.

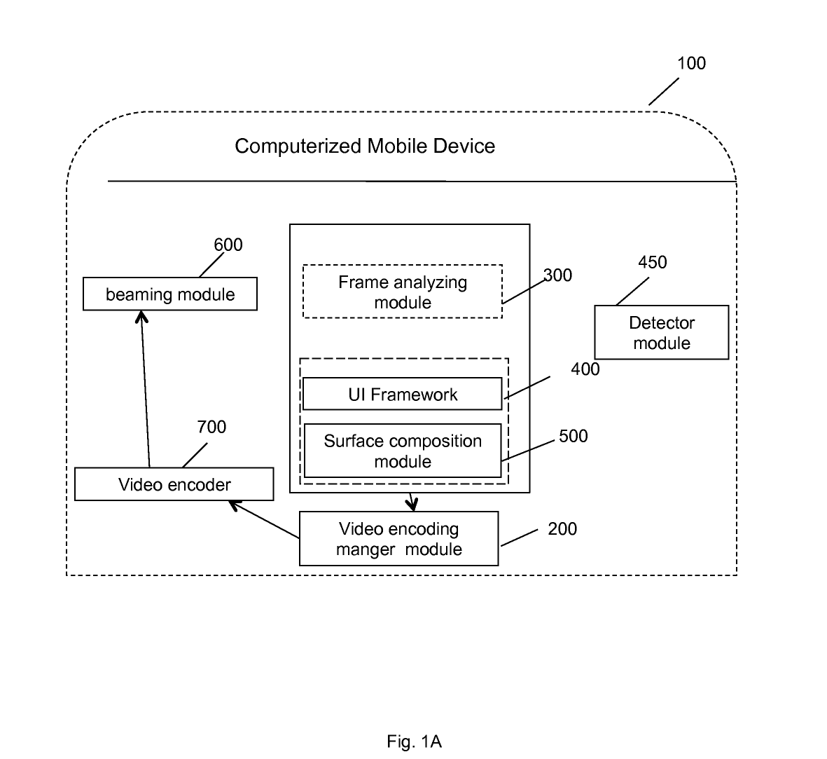

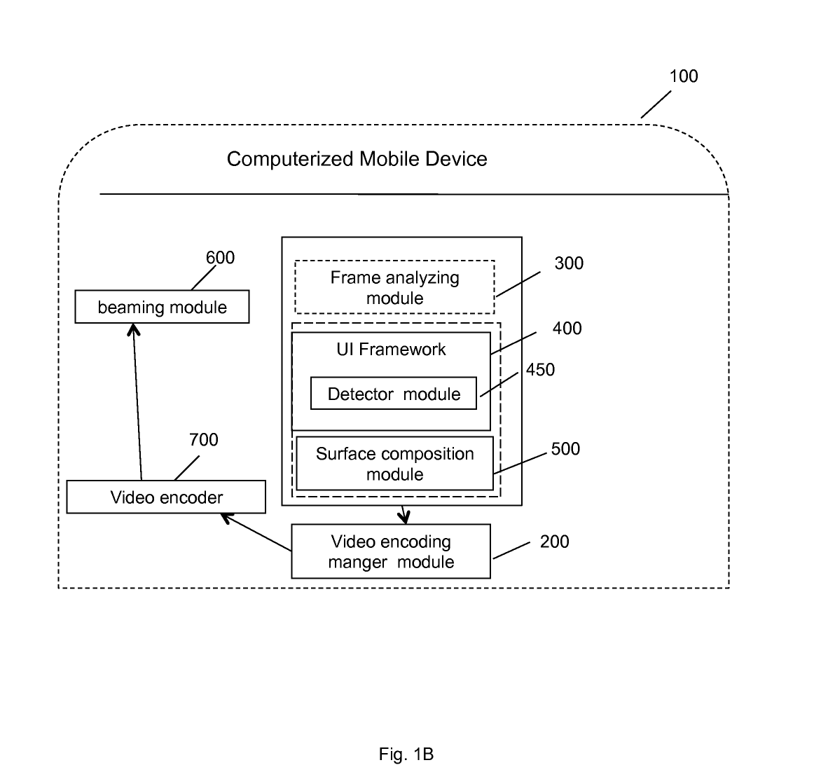

FIG. 1A is a block diagram, illustrating the modules of a beaming application in a computerized mobile device, wherein a detector module is separate to a UI framework, according to some embodiments of the invention. The computerized mobile device is comprised of: (i) surface composition module 500 (which is part of the OS of the computerized mobile device) that is enabling to integration of a surface of multiple applications into a single frame, to be displayed on a target display such as a television (TV) screen; (ii) a beaming module 600 to display on a target screen; (iii) a video encoding manager module 200 for managing and sending instructions related to the compression of the beamed video to a video encoder 700; (iv) a frame analyzing module 300 for analyzing the bit rate which is embedded in detector module 450; and (v) a UI framework code 400 (which is part of the computerized mobile device OS) for identifying critical frames.

FIG. 1B is a block diagram, illustrating the modules of a beaming application in a computerized mobile device, wherein a detector module 450 is part of a UI framework, according to some embodiments of the invention.

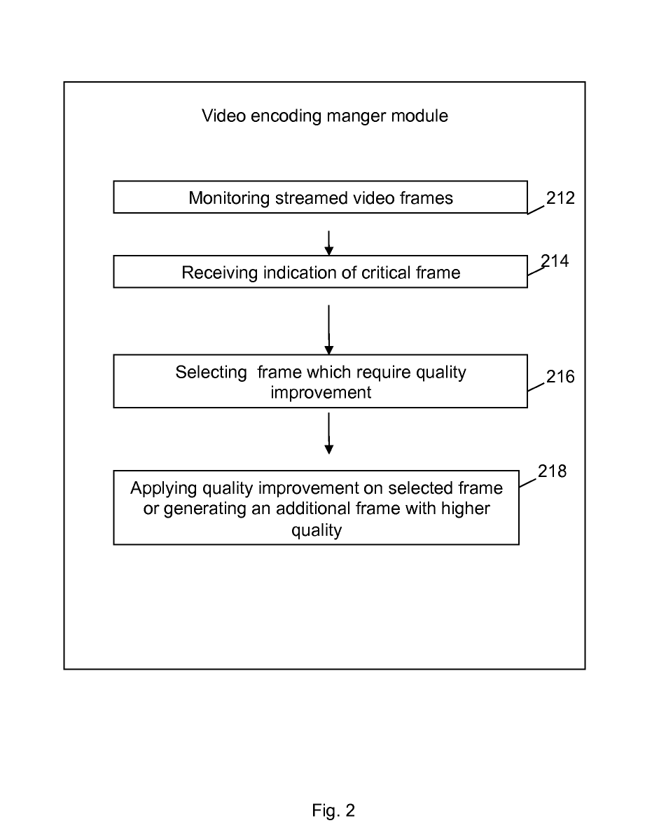

FIG. 2 is a flowchart illustrating at least part of the process of Video encoding module 200, according to some embodiments of the present invention. The process of Video encoding module 200 monitors video frames (stage 212) and receives indication of critical frames (stage 214). Next, according to received indication frames are selected for quality improvement (stage 216). Next, the qualities of the selected frames in the key period are improved (stage 218), providing improved experience to the user/viewer. The improvement may be achieved by changing the frames quality or adding new identical frames in better/higher quality.

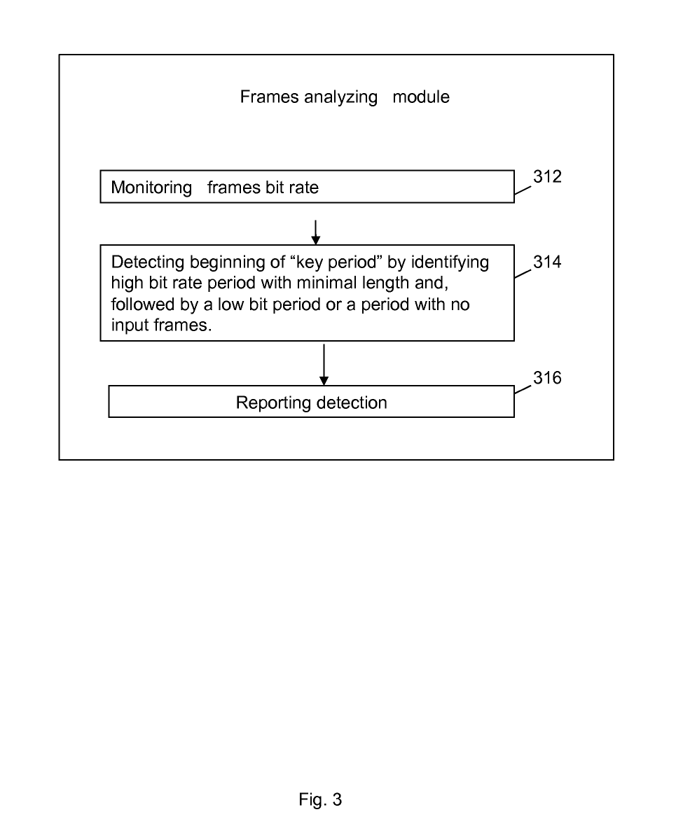

FIG. 3 is a flowchart illustrating at least part of the process of the frames analyzing module 300 according to some embodiments of the present invention. According to this embodiment the process of the frames analyzing module 300 monitors the bit rate or the change of content (stage 312), for detecting a predefined pattern of bit rate period such as key period in which a high bit rate period with minimal length is followed by a low bit period or a period with no input frames or for identifying increase of change of content (stage 314). Meaning, identifying in real time a pattern change in displayed video, wherein the pattern change signifies transition from a rate of a predefined size of chunk of delivered data to a higher delivered data rate in content displaying pattern by the application which starts a set of critical frames. The detected frames within the key period are marked and reported to the encoding module (stage 316).

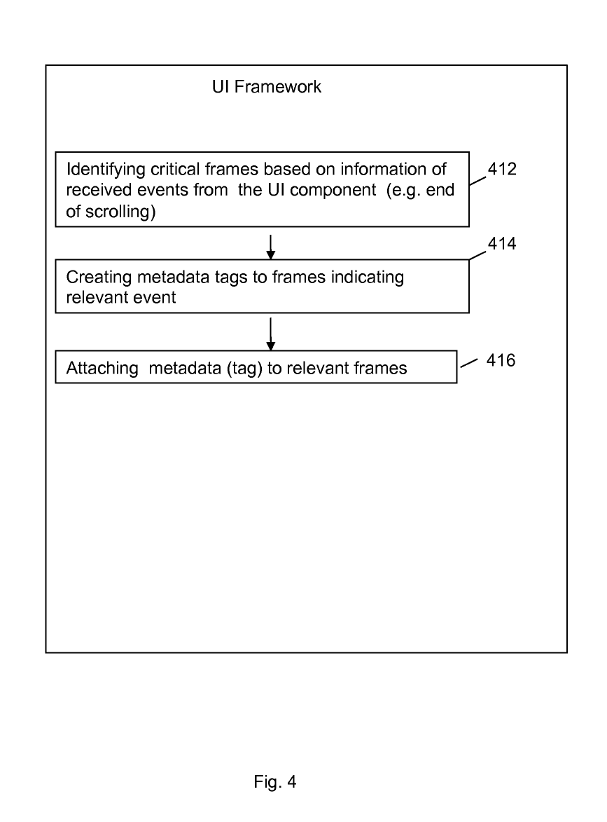

FIG. 4 is a flowchart schematically illustrating at least part of one of the UI framework processes, according to some embodiments of the present invention. According to this embodiment, the code identifies change which signifies transition in content displaying pattern is performed according to information that is received from a User interface (UI), such as end of scrolling of a webpage (stage 412) and creates metadata tags which include indication information of frames which are part of a key period (optionally) (stage 414). Next, the metadata tags are attached to the relevant frames (optionally) (stage 416). Optionally, sending the metadata tags separate from the relevant frames using frame IDs.

The tagged frames are enhanced by the encoding video module 300 for improving the quality.

According to some embodiments of the invention, the UI is of an Operating System (OS) or of the application that is running on the computerized mobile device.

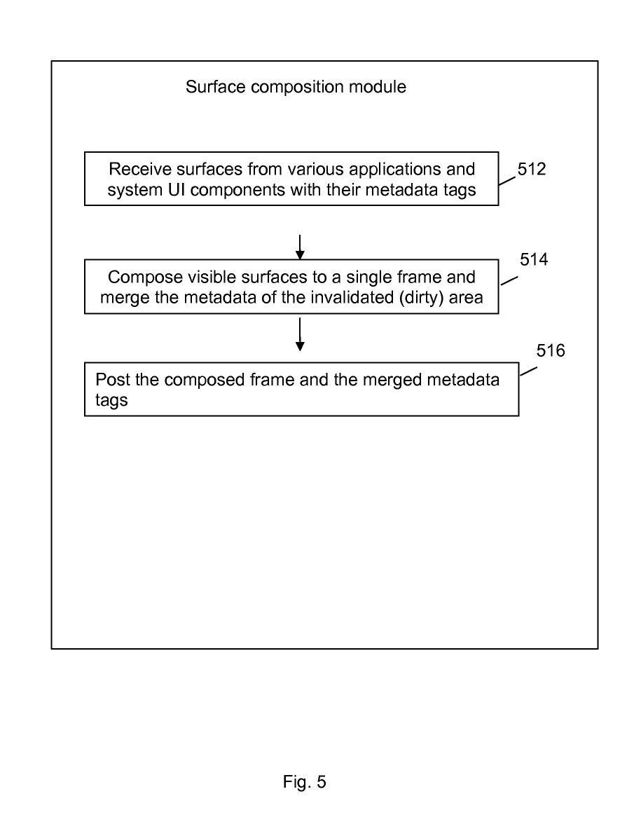

FIG. 5 is a flowchart schematically illustrating at least part of the process of surface composition module according to some embodiments of the present invention. The modules receives surfaces (screen images) from various applications running on the computerized mobile device and system UI components with their metadata tags (stage 512) and compose the visible surfaces to a single frame which is composition of all visible application surfaces. When composing the single frame the module merges the metadata of the invalidated (dirty) areas (modified area of the application) (stage 514). Finally, the composed frame and the merged metadata tags (stage 516) are posted.

Optionally, the beamed content is different from the displayed content on the mobile device screen.

According to some embodiments of the invention, the surface composition module may be a detector module.

It is to be understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention.

Furthermore, it is to be understood that the invention can be carried out or practiced in various ways and that the invention can be implemented in embodiments other than the ones outlined in the description above. It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included. Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalent

What is claimed is:

1. A method for improving quality of video beaming of any content by a beaming application that is running on a computerized mobile device, said method comprising the steps of:
selecting content for beaming;
beaming selected content by utilizing a beaming application;
identifying in real time a pattern change in beamed video, wherein the pattern change signifies transition from a previous rate of a predefined size of chunk of delivered data to a higher rate of currently delivered data in content displaying pattern by the application which starts a set of critical frames;
performing quality improvement of the video beaming of the set of critical frames based on the identified pattern changes; and
identifying in real time a second pattern change in display video to a lower delivered data rate which ends the set of critical frames,
wherein the identifying and the performing is running on at least one processing unit.

2. The method of claim 1, wherein higher delivered data rate is compressed data.

3. The method of claim 1, wherein higher delivered data rate is high bandwidth usage.

4. The method of claim 1, wherein the identifying is achieved by analyzing characteristics of the video frames.

5. The method of claim 1, wherein the performing of quality improvement of the video beaming is activated by selecting frames of the beaming video in low quality for quality improvement and applying quality improvement on the selected frames.

6. The method of claim 1, wherein the performing of quality improvement is achieved by generating an additional frame with a higher quality and adding the additional frame to the video beaming.

7. The method of claim 1, wherein the identifying of the change which signifies transition in content displaying pattern is performed according to information that is received from a User interface (UI) by attaching metadata tags which includes the information related to the beaming video frames.

8. The method of claim 1, wherein the UI is of an Operating System (OS).

9. The method of claim 1, wherein the UI is of the application that is running on the computerized mobile device.

10. The method of claim 1, wherein the identifying of the change which signifies pattern change in displayed video is performed according to information that is received from an Operation System (OS) or a User interface (UI) by sending metadata tags and identification (ID) of the critical frames.

11. The method of claim 1, wherein the identifying of the change which signifies transition in usage of the application is performed by analyzing an output bitrate of an encoder for detecting the change, wherein the change is characterized by a known pattern of bit rate.

12. The method of claim 5, wherein the known pattern includes a high bit rate period with minimal length followed by a low bit rate period or a period with no input frames.

13. A beaming application for improving quality of video beaming by a processing unit that is running on a computerized mobile device, said beaming application comprising:
a detector module for identifying in real time a pattern change in beamed video, wherein the pattern change signifies transition from a previous rate of a predefined size of chunk of delivered data to a higher rate of currently delivered data in content displaying pattern by the application; and
a video encoding module for performing quality improvement of the beaming video after the identified a pattern change in beamed video.

14. The beaming application of claim 13, wherein the detector module is comprising of a frame analyzing module for monitoring bit rate of frames of the beaming video and detecting a change which signifies transition in usage of the application which starts a set of critical frames.

15. The beaming application of claim 13, wherein the detector module is part of a UI framework module for identifying critical frames based on information that is received from UI components; and a surface composition module for receiving information regarding critical frames from OS is part of the UI framework.

16. The beaming application of claim 15, wherein the UI framework module is further creating metadata tags to the identified critical frames and attaching the metadata tags to the critical frames.

17. The beaming application of claim 15, wherein the UI framework module is further creating metadata tags to the identified critical frames and identification (ID) of the critical frames and sends is separately from the critical frames.

18. The beaming application of claim 15, wherein the surface composition module is further attaching metadata tags which includes the information related to the beaming video frames.

19. The beaming application of claim 15, wherein the identifying of the change which signifies transition in usage of the application is performed by analyzing an output bitrate of an encoder for detecting the change, wherein the change is characterized by a known pattern of bit rate.

20. The beaming application of claim 15, wherein the known pattern includes a high bit rate period with minimal length followed by a low bit rate period or a period with no input frames.

21. The beaming application of claim 13, wherein the detector module identifies beginning of a set of critical frames and an end of the set of critical frames.
